(19) United States
(12) Patent Application Publication
(10) Pub. No.: US 2007/0055998 A1
(43) Pub. Date: Mar. 8, 2007

(54) Digital living network alliance system for providing data service of digital broadcast and method for processing data service

(75) Inventors: Seung-Mi Kang, Yongin-si (KR); Ho-Chul Shin, Seongnam-si (KR); Woo-Jun Choi, Suwon-si (KR); Young-Kyu Bae, Bucheon-si (KR); Chul-Seung Kim, Suwon-si (KR); Young-Seop Han, Suwon-si (KR); Joon Oo Kim, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/516,215

(22) Filed: Sep. 6, 2006

(30) Foreign Application Priority Data
Sep. 7, 2005 (KR) 83255/2005

(51) Int. Cl. H04N 7/18; H04N 7/173

(52) U.S. Cl. 725/81; 725/80; 725/109; 725/110

(57) ABSTRACT

A system and method for Digital Living Network Alliance (DLNA) system is disclosed that provides data service of a digital broadcast. The DLNA system includes a digital media server for providing information about a broadcast A/V and data so as to handle a request for the data when a digital broadcast is requested, the digital media server receiving the digital broadcast and dividing the received digital broadcast into a broadcast A/V part and a data part so as to download the broadcast A/V part and the data part, respectively, and a digital media player for requesting the digital media server to transmit information about the digital broadcast, and to transmit data after receiving information about the broadcast A/V part and the data part from the digital media server, and for receiving and carrying out the requested data.

### CLAIM OF PRIORITY

This application claims priority to an application entitled “Digital Living Network Alliance System For Providing Data Service Of Digital Broadcast and Method For Processing Data Service,” filed with the Korean Intellectual Property Office on Sep. 7, 2005 and assigned Serial No. 2005-83255, the contents of which are incorporated herein by reference.

### BACKGROUND OF THE INVENTION

1. Field of the Invention

The present invention relates to a method for providing digital contents for a Digital Living Network Alliance (DLNA) system, and more particularly to a method for providing a data service including digital contents, based on a digital broadcast.

2. Description of the Related Art

Home-network technology is a networking technology for providing a future-oriented home environment, in which all information appliances in a home are connected to one another through a wire-line or wireless network so that a user is provided with various and high quality home services regardless of time and place.

Since home-network technology is regarded as a starting point for a ubiquitous home network environment and is considered to be the future of home-based technology, research in this area is on-going. Currently, the Digital Living Network Alliance (DLNA) has as its objective standardization of home-network technology. The DLNA is a successor standardization organization to the conventional Digital Home Working Group (DHWG), and was established on June, 2003, by MicroSoft, IBM, HP and Intel, which are American companies, Sony and Matsushita which are Japanese companies, and Samsung which is a Korean company, etc., in order to solve compatibility problems which had been a roadblock to the commercialization of home network systems.

The DLNA defines a network coexisting in a home as a PC internet network (PC, printer, etc.), a mobile network (PDA, portable terminals, and notebooks, etc.), and a home appliance network (TV, audio, and DVD player, etc.), and attempts to provide interoperability through as the three focus areas of cooperation of primary industries, standardization of interoperability framework, and products satisfying the standard of the DLNA.

In particular, the technology that the DLNA is concerned with allows consumers to obtain, transmit, and manage various digital media contents from a personal device such as a mobile device or a personal computer. Specifically, the technology allows the consumer to conveniently enjoy the media contents regardless of location and device at home.

To this end, the DLNA has promulgated the standardization of a physical media, a network transmission, a media format, a streaming protocol, a Digital Right Management (DRM), etc.

Hereinafter, the DLNA is described in more detail. First, a network connection according to the DLNA is based on an Internet Protocol (IP). The IP is a basic network communication protocol for devices operated on the Internet, which allows information to be exchanged in a transparent manner in an application program operated on various media.

For example, a PC or a Set-top Box (STB) can wirelessly transmit media contents to TVs at home through an IEEE 802.11 Access Point (AP) connected to an Ethernet cable. As described above, all devices according to the DLNA may communicate through the IP with any device connected to the Internet throughout the world.

On the other hand, physical layers of the DLNA include a wire-line high speed Ethernet IEEE 802.11u and a wireless Ethernet IEEE 802.11a/b/g. In the case of the wire-line Ethernet, its stability has been already proven, and in the case of the wireless Ethernet, as deployment of wireless home network increases, Wi-Fi is employed.

Further, technology exists for finding and controlling a device in the DLNA network and to automatically configure a network setting such as an IP address and recognize another device in the network so as to manage the DLNA network and is based on conventional universal plug and play UPnP AV Architecture and UPnP Device Architecture.

According to the DLNA, a device class may be classified into a Digital Media Server (DMS) and a Digital Media Player (DMP). The former plays the role of a Media Server Device (MSD), i.e. a server supplying media, in the UPnP AV specification, while the latter plays the role of a Media Render Device (MRD) and a Media Render Control Point (MRCP), i.e. selecting and controlling media and playing the selected media.

FIG. 1 is a block diagram illustrating a configuration of a Digital Living Network Alliance (DLNA) system to which the present invention is applied.

As illustrated in FIG. 1, the DLNA system includes a Digital Media Server (DMS) 13 for providing multimedia contents, a Mobile-Digital Media Player (M-DMP) 11 for rendering the multimedia contents, and a Mobile-Network Connection Function 12 used as an intermediate node for connecting the DMS 13 and the M-DMP 11. Generally, DMP 11 includes wire-line and wireless DMPs, but herein, only the M-DMP 11 is described in order to emphasize wireless function functionality. However, the wire-line DMP is not excluded. Herein, the DMS 13 comprises a broadcasting receiving device and a broadcasting middleware in order to receive the digital broadcasting.

In order to provide the digital broadcasting service, the DLNA defines the standard for the necessary technologies. The standard is as follows:

First, broadcasting A/V data 101 contained in the digital broadcasting service is packetized in a stream format of data (MPEG-2 data) and transmitted to the IP network, i.e. in the DLNA system. Further, the DMS 13 expresses broadcasting channels as one resource so that the M-DMP 11 can render IP streaming from the resource. Further, the DMS 13 can obtain Service Information (SI) and application data of the broadcasting stream contained in the digital broadcasting service through a High-Density TV decoder. In addition, the DMS 13 can parse and execute the service information and application data through the included broadcasting middleware, for example, MHP, ACAP, and OCAP, etc.

In the case where such a DLNA system provides the digital broadcasting service, according to a scenario for supplying multimedia data which can satisfy the DLNA standard based on the conventional UPnP as described above, when the DMS 13 expresses content, i.e. broadcasting A/V 101, corresponding to each channel of the received digital broadcasting service as a resource like one image file, and stores the resource, the M-DMP 11 selects and IP-streams the resource so that a user can be provided with the service.

Therefore, in the case where the M-DMP 11 receives the digital broadcast through the conventional art, the M-DMP 11 receives only the broadcasting A/V 101 from the data broadcast consisting of the broadcasting A/V 101, the application 102 and the service information 103.

FIG. 2 is an exemplary view showing an interface screen for providing digital broadcast from a DMS to an M-DMP according to a conventional art.

As shown in FIG. 2, when the M-DMP 11 receives only information on each channel 21, 22, and 23 in the form of a resource and selects the corresponding channel, the DMS 13 IP-streams and provides the broadcasting A/V content of the channel, so that the user can be provided with the broadcasting service.

FIG. 3 is a view illustrating a method for receiving a digital broadcast in a conventional DLNA system.

Referring to FIG. 3, first, when the user selects a desired channel from the channels of FIG. 2, provided by the DMS 13, through the control point of the M-DMP 11, the M-DMP 11 sends the DMS 13 a message of “getchannels( ) action” in order to obtain information about the corresponding channel at step 301.

Further, the DMS 13 responds to the “getchannels( ) action” and sends the M-DMP 11 a message of “channel URL” which indicates a position at which the corresponding channel is stored, at step 302.

Then, the M-DMP 11 sends the DMS 13 a message of “HTTP GET” requesting the transmission of the AN content of the corresponding URL at step 303.

Next, the DMS 13 provides the M-DMP 11 with the corresponding A/V content at step 304.

As described above, the conventional method for receiving the digital broadcast is not different from the method for receiving general digital content.

However, the digital broadcasting service generally includes the data broadcast. The data broadcast cannot provide an independent service through the method illustrated in FIG. 3.

Specifically, as described above, the DMS 13 receives and executes the service information (SI) and the application data through a decoder. The reception and execution of the SI and the application data can be carried out only by the DMS 13. The DLNA standard does not provide a method by which the M-DMP 11 receives and executes the service information and the application data.

According to the conventional art, when the user executes the application contained in the data broadcast while his/her family watches TV connected to the DMS 13, his/her family cannot watch the TV because of the execution of such an application through the corresponding TV. For example, suppose a family of four is watching TV in a living room, when one family member executes an application through the DMS 13 in order to check today's weather, the application is displayed as a broadcast image, which the whole family must watch, in the form of On Screen Display (OSD). In another scenario, both images are resized and the broadcast image and the application screen are displayed at the same time. Thus, there is a disadvantage in that other members, who do not desire to check the weather, are inconvenienced.

Although the application data contained in the data broadcast are not classified into the A/V, the image, and the audio according to the content class of the DLNA, but nonetheless are an important element within the digital broadcast, the DLNA standard only sets definition for the treatment of the A/V streaming with relation to the broadcasting service. Thus, there is a problem in that proper treatment of the application data cannot be carried out.

### SUMMARY OF THE INVENTION

Accordingly, the present invention provides a DLNA system for supporting data service of digital broadcasting in a DMP in a ubiquitous environment, and a method for handling the data service in the DLNA system.

An alternative embodiment of the present invention provides a method for providing a digital broadcast in which A/V data, channel information, and applications are integrated with one another, instead of providing the digital broadcast as general A/V data.

According to an aspect of the present invention, there is provided a Digital Living Network Alliance (DLNA) system for providing data service of a digital broadcasting, which includes: a digital media server for providing information about a broadcast A/V and data so as to handle a request for the data when digital broadcast is requested, the digital media server receiving the digital broadcast and dividing the received digital broadcast into the broadcast A/V and the data so as to download the broadcast A/V and the data, respectively; and a digital media player for requesting the digital media server to transmit information about the digital broadcasting, and to transmit data after receiving information about the broadcast out the requested data.

In order to accomplish these objects of the present invention, according to another embodiment of the present invention, there is provided a method for processing data service of digital broadcasting in a Digital Living Network Alliance (DLNA) system which includes a digital media server for providing multimedia contents and a digital media player for executing the multimedia contents, which includes steps of: (1) providing, by a digital media server, service information and application information when a digital media player requests the digital media server to receive a digital broadcast; (2) downloading, by a digital media server, a desired application when the digital media player selects the desired application depending on the provided service information and application information; (3) when the download of the desired application has been completed, sending to the digital media player by the digital media server, detailed information about the desired application and information that the download of the desired application is completed; and (4) transmitting by the digital media server to the digital media player the downloaded application when a request to transmit the desired application is received by the digital media server from the digital media player.

According to another aspect of the present invention, there is provided a method for a processing data service of digital broadcast in a Digital Living Network Alliance (DLNA) system which includes a digital media server for providing multimedia contents and a digital media player for executing the multimedia contents, which includes steps of: (1) requesting by the digital media player that the digital media server receive a digital broadcast; (2) receiving by the digital media player service information and application information from the digital media server according to the requested digital broadcast; (3) selecting by the digital media player a desired application from the received service information and application information; (4) requesting by the digital media player that the digital media server download the selected application to the digital media player; (5) receiving by the digital media player from the digital media server, detailed information about the requested application and information and that the download of the desired application is completed; and (6) requesting by the digital media player that the digital media server transmit the downloaded application to the digital media player so as to receive and execute the desired application.

### BRIEF DESCRIPTION OF THE DRAWINGS

The above and other features and advantages of the present invention will be more apparent from the following detailed description taken in conjunction with the accompanying drawings, in which:

FIG. 1 illustrates a block diagram of a configuration of a Digital Living Network Alliance (DLNA) system to which the present invention is applied;

FIG. 2 illustrates an exemplary view of an interface screen for providing digital broadcasting from a DMS to an M-DMP according to a conventional art;

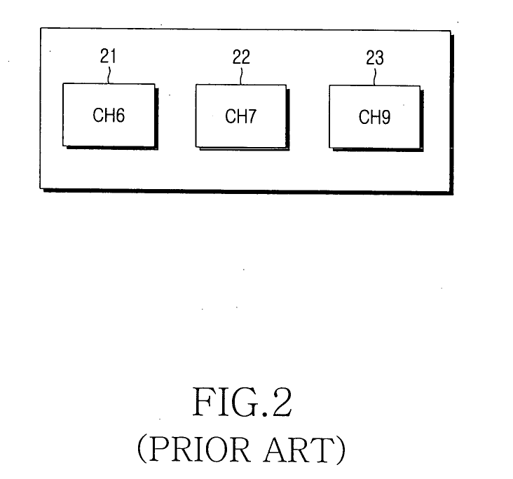

FIG. 3 illustrates a view of a method for receiving a digital broadcast in a conventional DLNA system;

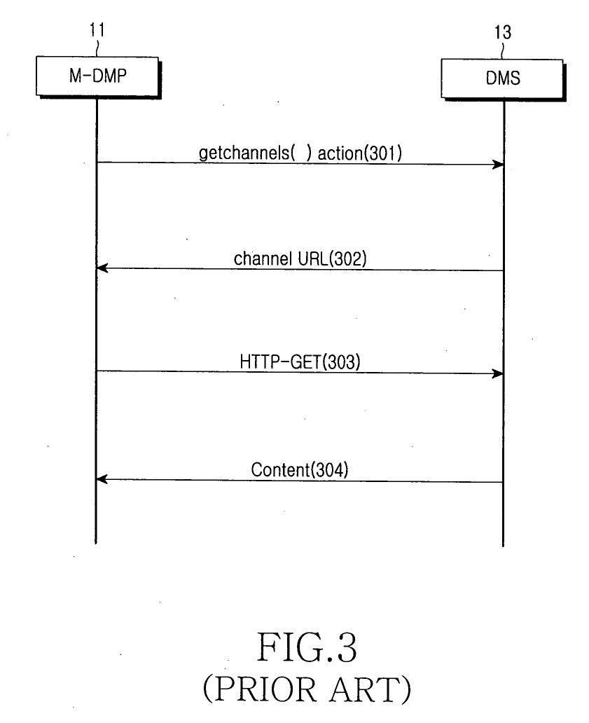

FIG. 4 illustrates a view of an application information display screen which is based on a Service Information (SI) transmitted to an M-DMP according to the present invention; and

FIG. 5 illustrates a view of a method for providing a data service in a DLNA system so that the data service of the digital broadcast in the DLNA system can be used in the M-DMP, according to the present invention.

### DETAILED DESCRIPTION OF THE INVENTION

Hereinafter, an embodiment of the present invention is described in detail with reference to the accompanying drawings. For the purposes of clarity and simplicity, a detailed description of known functions and configurations incorporated herein is omitted to avoid making the subject matter of the present invention unclear.

The present invention is a method for carrying out data service in a digital broadcasting service through an M-DMP in a DLNA system.

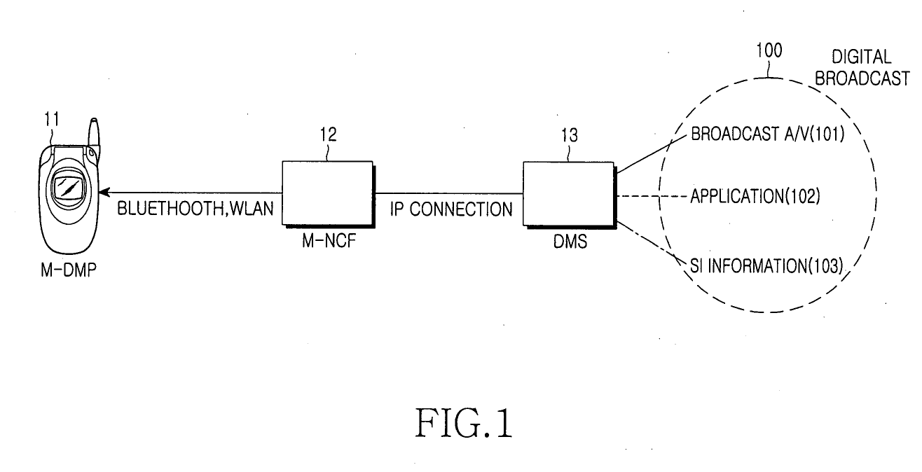

FIG. 1 illustrates a block diagram showing a configuration of a Digital Living Network Alliance (DLNA) system to which the present invention is applied.

As illustrated in FIG. 1, the DLNA system includes a Digital Media Server (DMS) 13 for providing multimedia contents, a Mobile-Digital Media Player (M-DMP) 11 for rendering the multimedia contents, and a Mobile-Network Connection Function 12 used as an intermediate node for connecting the DMS 13 and the M-DMP 11. Generally, DMP includes wire-line and wireless DMPs, but herein, only the M-DMP 11 is described in order to emphasize a wireless function. However, the wire-line DMP is not excluded. Here, the DMS 13 includes a broadcasting receiving device and a broadcasting middleware in order to receive the digital broadcasting.

In the DLNA system according to the present invention, the digital broadcast 100 includes applications 102 and service information 103 as well as broadcast A/V 101, which is input to the DMS 13, is transmitted to the M-DMP 11 so that each M-DMP 11 can independently execute the application 102 or process the service information 103.

Hereinafter, the operation of respective elements according to the present invention is described.

First, the DMS 13 receives terrestrial digital broadcasts, satellite digital broadcasts, cable digital broadcasts, etc., and distinguishes the input broadcast A/V 101, the application 102, and the Service Information (SI) 103 from one another so as to download each of them.

The downloaded application 102 and the service information 103 are transmitted through an IP network to the M-DMP 11, so that the M-DMP 11 can use them individually.

Further, the DMS 13 receives and processes the digital broadcast and then provides the M-DMP 11 with the digital broadcast. Thus, the M-DMP need not include a broadcast receiver device.

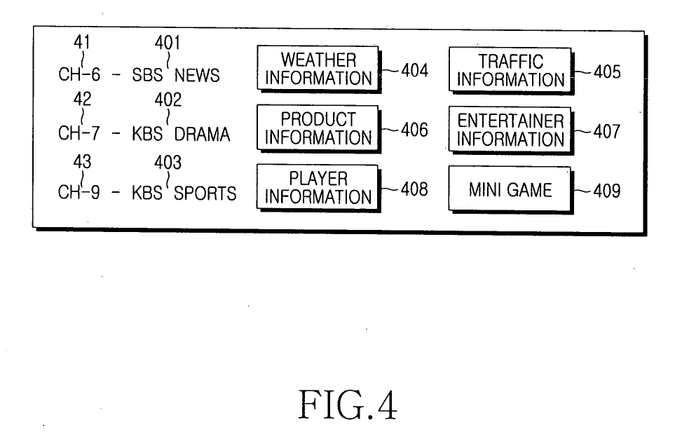

FIG. 4 illustrates a preferred embodiment of an application information display screen based on a Service Information (SI) transmitted to an M-DMP 11 according to the present invention.

Referring to FIG. 4, the application information display screen based on service information transmitted to the M-DMP 11 according to the present invention includes information on each channel 41, 42, or 43, the title of the corresponding channel 401, 402, or 403, and applications contained in each channel 404-409.

Specifically, “SBS News” 401 of the channel No. 6 41 includes applications such as “weather information” 404 which is a data application to display information about weather, and “traffic information” 405 which is a data application to display information about traffic.

Further, “KBS drama” 402 of the channel No. 7 42 includes applications such as “product information” 406 which is a data application to provide information about products shown in “entertainer information” 407 which is a data application to display information on actors and actresses appearing in a drama.

In addition, “KBS Sports” 403 of channel No. 9 43 includes applications such as “player information” 408 which is a data application to display information about players and “mini game” 409 which is a data application to provide a mini game relating to the corresponding sport.

As described above, in order to use the applications 102 and the service information 103 in the M-DMP 11, a protocol is required to carry out a data service between the M-DMP 11 and the DMS 13.

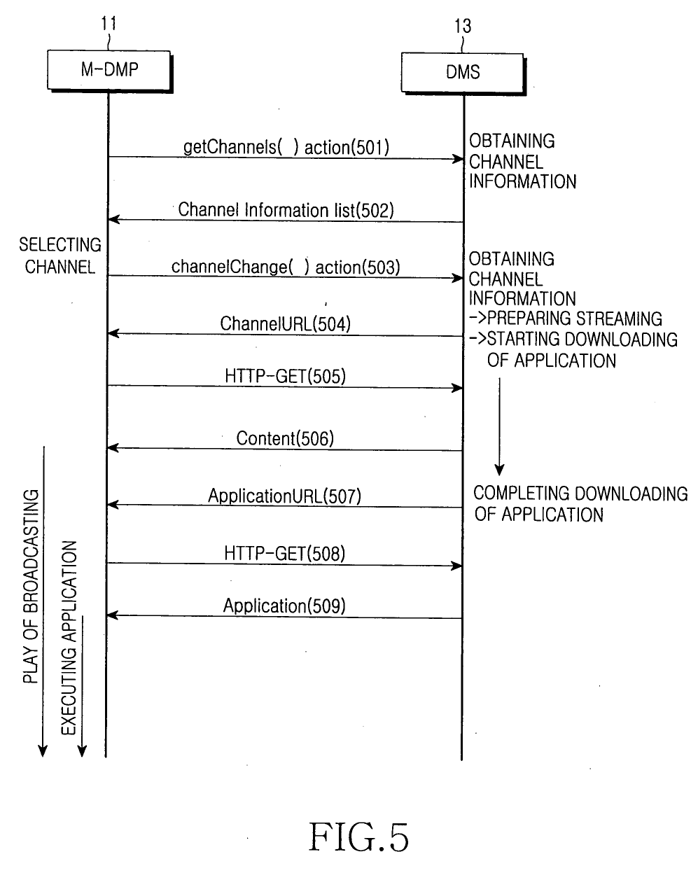

FIG. 5 illustrates a method for providing a data service in a DLNA system so that the data service of the digital broadcasting in the DLNA system can be used in the M-DMP, according to the present invention.

Referring to FIG. 5, in the method for providing a data service in a DLNA system so that the data service of the digital broadcast in the DLNA system can be used in the M-DMP, when a user first selects a desired channel through a control point of the M-DMP 11, the M-DMP 11 sends the DMS 13 a message of “getchannels( ) action” in order to receive the desired channel from the DMS 13 at step 501. Here, the phrase “getchannels( ) action” is the message of informing the DMS 13 that it is about to receive the digital broadcast.

At this time, the DLNA system according to the present invention must obtain information about a corresponding channel because of recognition that the broadcast channel contains other information as well as the broadcast A/V. To this end, a message newly defined by the present invention includes a message of “channel information list” 502 used for providing service information and basic application information of the selected channel, and a message of “channelChange( ) action” 503 used for requiring the change into a sub-channel in a case of selecting the application.

On the other hand, the DMS 13 receiving the message of “getChannels( ) action” 501 sends the M-DMP 11 a message of “Channel Information list” 502 in order to provide the M-DMP 11 with the service information and basic application information about the corresponding channel. Here, the basic application information refers to general information about the application 102.

Then, the M-DMP 11, having received the information about the broadcast A/V 101 and the application through the message of “Channel Information” from the corresponding channel, selects the desired application depending on the received information and sends the DMS 13 a message of “channelChange( ) action” 503 requiring a change of the sub-channel into the corresponding service.

Next, the DMS 13 responds to the message of the “channelchange( ) action” 503 so as to send the M-DMP 11 a message of “channel URL” 504 indicating a position at which the broadcast A/V 101 is contained in the corresponding channel. At this time, the DMS 13 is ready to carry out the streaming of the broadcast A/V 101 and download the selected application. In this case, the download of the application may be an initial download from another broadcasting system, or a download of cached data.

The M-DMP 11 sends the DMS 13 a message of “HTTP GET” 505 requesting the DMS 13 to transmit the broadcast A/V content of the corresponding URL.

The DMS 13 provides the M-DMP 11 with the corresponding broadcast A/V content at step 506.

When the DMS 13 completes the download of the corresponding application and while the M-DMP 11 receives the broadcast A/V content 101 through the message of “HTTP-GET” 505, the DMS 13 sends the M-DMP 11 a message of “ApplicationURL” 507 displaying a position at which the application is downloaded and stored and detailed information of the corresponding application. At this time, since the downloading of the applications have different completion times, the DMS 13 informs the M-DMP 11 in the form of an event.

The M-DMP 11 sends the DMS 13 a message of “HTTP GET” 508 requesting the DMS 13 to transmit applications of the corresponding URL.

The DMS 13 provides the M-DMP 11 with the corresponding application at step 509.

An example of the configuration of messages newly defined in the form of XML depending on the method for providing data service in the DLNA system according to the present invention shown in FIG. 5, in which the M-DMP can use the data service of the digital broadcasting, is illustrated in Table 1 to Table 5.

First, Table 1 illustrates an XML body with respect to the message of “getChannel( ) action” 503.

TABLE 1

< s : E n v e l o p e
xmlns:s=”http://schemas.xmlsoap.org/soap/envelop/”
s:encodingStyle=”http://schemas.xmlsoap.org./soap/encoding/”>
<s:Body>
<u:getChannels xmlns:u=”urn:schemas-upnp-org:service:
ContentDirectory:1”>
</u:getChannels>
</s:Body>
</s:Envelope>

Table 2 illustrates an XML body relating to the message of “Channel Information list” 502 which responds to the message of“getChannels( ) action” 501.

TABLE 2
< s : E n v e l o p e
xmlns:s=”http://schemas.xmlsoap.org/soap/envelop/”
s:encodingStyle=”http://schemas.xmlsoap.org./soap/encoding/”>
<s:Body>
<u:getChannelsResponse xmlns:u=”urn:schemas-upnp-
org:service:ContentDirectory:1”>
<Result>
<DIDL-Lite xmlns=”urn:schemas-upnp-org:metadata-1-0/DIDL-Lite/”
xmlns:dc=”http://purl.org/dc/elements/1.1/”
xmlns:upnp=”urn:schemas-upnp-org:metadata-1-0/upnp/”>
<ChannelNumber>6
<friendlyname>SBS</friendlyname>
<description>Solomon's choice</description>
</ChannelNumber>
<Application-Infor>
<friendlyname>SBS Application</friendlyname>
<description>SBS News</description>
</Application-Info>
</u:getChannelsResponse>
</s:Body>
</s:Envelope>

According to the example illustrated in Table 2, the selected channel number is “six,” and the broadcast is “SBS.” Further, the program name of the broadcast is “Solomon's Choice,” and the application contained in the program is “SBS News.”

Table 3 exemplarily shows an XML body with relation to the message of “channelChange( ) action” at step 503.

TABLE 3

< s : E n v e l o p e
xmlns:s=”http://schemas.xmlsoap.org/soap/envelop/”
s:encodingStyle=”http://schemas.xmlsoap.org./soap/encoding/”>
<s:Body>
<u:changeChannels xmlns:u=”urn:schemas-upnp-org:service:
ContentDirectory:1”>
<channelNumber>6<channelNumber>
</u:changeChannels>
</s:Body>
</s:Envelope>

Table 4 illustrates an XML body with respect to the message of “ChannelURL” 504 which is a response to the message of “channelChange( ) action” 503.

TABLE 4
< s : E n v e l o p e
xmlns:s=”http://schemas.xmlsoap.org/soap/envelop/”
s:encodingStyle=”http://schemas.xmlsoap.org./soap/encoding/”>
<s:Body>
<u:getChannelsResponse xmlns:u=”urn:schemas-upnp-
org:service:ContentDirectory:1”>
<Result>
<DIDL-Lite xmlns=”urn:schemas-upnp-org:metadata-1-0/DIDL-Lite/”
xmlns:dc=”http://purl.org/dc/elements/1.1/”
xmlns:upnp=”urn:schemas-upnp-org:metadata-1-0/upnp/”
xmlns:dlna=”urn:schemas-dlna-org:metadata-1-0/”>
<channelNumber>6
<res>http://165.213.224.71/TVchannel/6/˜ broadcast
</res>
</channelNumber>
</u:changeChannelsResponse>
</s:Body>
</s:Envelope>

Table 5 illustrates an XML body with relation to the message of “ApplicationURL” 507.

TABLE 5
<e:propertyset xmlns:e=”urn:schemas-upnp-org:event-1-o”
<e:property>
<Application-Info>6
<applicationURL type=”dvb-
j”>http://165.213.224.71/TVchannel/6/˜ application</applicationURL>
</Application-Info>
</e:property>
</e:propertyset>

The method of the present invention as described above is realized in the form of a computer executable program, which can be stored in a recording medium, such as a CD-ROM, a RAM, a floppy disc, a hard disc, and an optical-magnetic disc, etc., so as to be readable by a computer.

According to the present invention, in the case where users use a data service of the digital broadcast based on the DLNA system, the DLNA system allows each user to carry out the data service independently, thereby increasing the convenience of user using digital broadcast service.

Further, according to the present invention, since the DMS handles all the digital broadcasts of the DLNA system, the broadcasts can be received by only the content player even though the DMP has no broadcast receiver.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A Digital Living Network Alliance (DLNA) system for providing data service of a digital broadcasting, comprising:
a digital media server for providing information on a broadcasting A/V and data so as to handle a request for the data when a digital broadcast is requested, the digital media server receiving the digital broadcast and dividing the received digital broadcast into a broadcast A/V part and a data part so as to download the broadcast A/V part and the data part, respectively; and
a digital media player that requests the digital media server to transmit information about the digital broadcast, and to transmit data after receiving information about the broadcast A/V part and the data part from the digital media server, and for receiving and carrying out the received data.

2. The DLNA system as claimed in claim 1, wherein the received data includes service information about the digital broadcast and applications transmitted through the digital broadcast.

3. A method for processing a data service of a digital broadcast in a Digital Living Network Alliance (DLNA) system which includes a digital media server for providing multimedia contents and a digital media player for executing the multimedia contents, the method comprising steps of:
(1) the digital media server providing service information and application information when the digital media player requests the digital media server to receive the digital broadcast;
(2) the digital media server downloading a desired application to the digital media player when the digital media player selects the desired application based on the provided service information and the application information;
(3) the digital media server transmitting detailed information about the desired application and when the download of the desired application has been completed, transmitting information that the download of the desired application is completed; and
(4) the digital media server providing the downloaded application to the digital media player when a request to transmit the desired application is received by the digital media server from the digital media player.

4. The method as claimed in claim 3, wherein the downloading step (2) further comprises steps of:
(2.1) streaming A/V content of the digital broadcast; and
(2.2) providing the digital media player with information indicating a storage location of the A/V content.

5. The method as claimed in claim 4, further comprising the step of (2.1.2) providing the digital media player with the A/V content when the digital media player requests the transmission of the A/V content.

6. The method as claimed in claim 3, wherein the transmitted detailed information about the desired application includes a detailed description of the desired application and a position at which the desired application is downloaded and stored.

7. The method as claimed in claim 6, wherein the transmitting step (3) is carried out as an event operation of the digital media server with respect to the digital media player.

8. A method for processing a data service of a digital broadcast in a Digital Living Network Alliance (DLNA) system which includes a digital media server for providing multimedia contents and a digital media player for executing the multimedia contents, the method comprising steps of:
(1) the digital media player requesting the digital media server to receive the digital broadcast;
(2) the digital media player receiving service information and application information from the digital media server about the requested digital broadcast;
(3) the digital media player selecting a desired application from the received service information and the application information provided so as to request the digital media server to provide the application;
(4) the digital media player receiving from the digital media server detailed information about the selected desired application and information that the download of the selected desired application is completed; and
(5) the digital media player requesting the digital media server to transmit the downloaded application so as to receive and execute the desired application by the digital media player.

9. The method as claimed in claim 8, wherein the downloading step (2) further comprises the steps of:
(6) the digital media server transmitting to the digital media player information indicating a storage position of the A/V content according to the request for the digital broadcast at step (1); and
(7) the digital media player requesting and receiving from the digital media server the corresponding A/V content according to the transmitted information indicating the storage position of the A/V content.

10. The method as claimed in claim 8, wherein the detailed information about the desired application includes a detailed description of the desired application and a position at which the desired application is downloaded and stored.

11. The method as claimed in claim 10, wherein the receiving step (4) is carried out as an event operation of the digital media server.
